(19) United States
(12) Patent Application Publication
(10) Pub. No.: US 2024/0113853 A1
(43) Pub. Date: Apr. 4, 2024

(54) TIME SYNCHRONIZATION DEVICE, TIME SYNCHRONIZATION METHOD, AND RECORDING MEDIUM

(71) Applicant: NEC Corporation, Tokyo (JP)

(72) Inventor: Daichi ISHIKURA, Tokyo (JP)

(73) Assignee: NEC Corporation, Tokyo (JP)

(21) Appl. No.: 18/373,733

(22) Filed: Sep. 27, 2023

(30) Foreign Application Priority Data
Oct. 4, 2022 (JP) 2022-159936

(51) Int. Cl. H04L 7/00

(52) U.S. Cl. CPC H04L 7/0012

(57) ABSTRACT

A time synchronization device includes: a transmission/reception unit; a time information generation unit that generates internal time information indicating an internal time being a time inside the time synchronization device; and a time synchronization unit that performs time synchronization processing being processing of synchronizing the internal time with a master time being a time of a master device, wherein synchronization of the internal time is performed by using a packet for time synchronization transmitted between the master device and the time synchronization device, and the time synchronization unit inhibits inhibition target processing being processing of at least a part of the time synchronization processing when at least one of transmission and reception of a packet other than the packet for time synchronization is performed, and performs the inhibition target processing when transmission and reception of a packet other than the packet for time synchronization are not performed.

This application is based upon and claims the benefit of priority from Japanese Patent Application No. 2022-159936, filed on Oct. 4, 2022, the disclosure of which is incorporated herein in its entirety by reference.

### TECHNICAL FIELD

The present invention relates to a time synchronization device and the like.

### BACKGROUND ART

A radio access scheme such as long term evolution (LTE) or 5th generation (5G) requires high precision in time synchronization between base stations for interference suppression or handover between base stations. The required precision is that a time deviation between base stations needs to be equal to or less than 1.5 μs.

A generally used scheme for time synchronization of a server or the like is a time synchronization scheme using a network time protocol (NTP) packet. However, precision of this scheme is usually about a few milliseconds, which does not meet the precision required for time synchronization between base stations.

Further, a high-precision time synchronization scheme is a time synchronization scheme using a signal of a global navigation satellite system (GNSS). In this scheme, a radio signal from a GNSS satellite is used for time synchronization. However, time synchronization of a large number of pieces of equipment (for example, base stations) by a GNSS signal requires wiring of an antenna cable and installation of an amplification distributor or the like, resulting in a high introduction cost.

Further, a scheme for high-precision time synchronization via a local area network (LAN) has been proposed. A scheme for time synchronization via a LAN is, for example, a time synchronization scheme using the Institute of Electrical and Electronics Engineers (IEEE)-1588 precision time protocol (PTP). In PTP, a packet for time synchronization transmitted/received over a LAN is used for time synchronization. In PTP, time information is stored in a packet for time synchronization transmitted/received between a master device and a slave device. Then, the slave device calculates a propagation time in transmission/reception of a packet by using the time information stored in the packet for time synchronization and a transmission/reception time of the packet, and performs time synchronization by using the propagation time. In PTP, the propagation time is used for time synchronization, and thereby high-precision time synchronization is achieved.

However, when time synchronization using PTP is performed, a PTP-compliant device needs to be selected as a relay device. In a general network, a packet transmitted/received between a master device and a slave device may pass through a plurality of relay devices (for example, Layer 2 switches or the like). When PTP is used in such a network, the relay device itself needs to be compliant with PTP and correct a delay caused by transmission/reception of a packet, in order to correct a delay time caused by transmission/reception of a packet in the relay device. When the relay device is not compliant with PTP, precision in time synchronization between the master device and the slave device deteriorates. When all of the relay devices are to be PTP-compliant products, it is necessary to purchase PTP-compliant relay devices, replace existing relay devices with PTP-compliant relay devices, or the like. Thus, it is not practical that all of the relay devices are to be PTP-compliant products.

### SUMMARY

In view of the above-described problem, an object of the present invention is to provide a time synchronization device and the like that enable improvement of precision in time synchronization.

In one aspect of the present invention, a time synchronization device is a time synchronization device connecting to a master device, and includes: a transmission/reception unit that transmits/receives a packet; a time information generation unit that generates internal time information indicating an internal time being a time inside the time synchronization device; and a time synchronization unit that performs time synchronization processing being processing of synchronizing the internal time with a master time being a time of the master device, wherein synchronization of the internal time is performed by using a packet for time synchronization transmitted between the master device and the time synchronization device, and the time synchronization unit inhibits inhibition target processing being processing of at least a part of the time synchronization processing when at least one of transmission and reception of a packet other than the packet for time synchronization is performed by the transmission/reception unit, and performs the inhibition target processing when transmission and reception of a packet other than the packet for time synchronization are not performed by the transmission/reception unit.

Further, in another aspect of the present invention, a time synchronization method is a time synchronization method for a time synchronization device connecting to a master device, and includes: transmitting/receiving a packet; generating internal time information indicating an internal time being a time inside the time synchronization device; and performing time synchronization processing being processing of synchronizing the internal time with a master time being a time of the master device when transmission and reception of a packet other than a packet for time synchronization are not performed, and inhibiting inhibition target processing being processing of at least a part of the time synchronization processing when at least one of transmission and reception of a packet other than the packet for time synchronization is performed, wherein synchronization of the internal time is performed by using a packet for time synchronization transmitted between the master device and the time synchronization device.

Further, in another aspect of the present invention, a time synchronization program recorded on a non-transitory computer-readable recording medium is a time synchronization program of a time synchronization device connecting to a master device, and causes a computer to achieve: a transmission/reception function of transmitting/receiving a packet; a time information generation function of generating internal time information indicating an internal time being a time inside the time synchronization device; and a time synchronization function of performing time synchronization processing being processing of synchronizing the internal time with a master time being a time of the master device, wherein synchronization of the internal time is performed by using a packet for time synchronization transmitted between the master device and the time synchronization device, and the time synchronization function inhibits inhibition target processing being processing of at least a part of the time synchronization processing when at least one of transmission and reception of a packet other than the packet for time synchronization is performed by the transmission/reception function, and performs the inhibition target processing when transmission and reception of a packet other than the packet for time synchronization are not performed by the transmission/reception function.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration example of a time synchronization device according to a first example embodiment of the present invention;

FIG. 2 is a diagram illustrating an example of an operation flow of a time synchronization device according to a first example embodiment of the present invention;

FIG. 3 is a diagram illustrating a configuration example of a system including a time synchronization device according to a second example embodiment of the present invention;

FIG. 4 is a diagram illustrating a configuration example of the time synchronization device according to the second example embodiment of the present invention;

FIG. 5 is a diagram illustrating an example of an operation flow of the time synchronization device according to the second example embodiment of the present invention;

FIG. 6 is a diagram illustrating an example of another operation flow of the time synchronization device according to the second example embodiment of the present invention;

FIG. 7 is a diagram illustrating an example of another operation flow of the time synchronization device according to the second example embodiment of the present invention;

FIG. 8 is a diagram illustrating a configuration example of a system when the time synchronization device according to the second example embodiment of the present invention is applied to a base station; and

FIG. 9 is a diagram illustrating a hardware configuration example according to each example embodiment of the present invention.

### EXAMPLE EMBODIMENT

### First Example Embodiment

A first example embodiment of the present invention will be described. One specific example of a time synchronization device 10 according to the first example embodiment is a time synchronization device 20-i according to a second example embodiment to be described later.

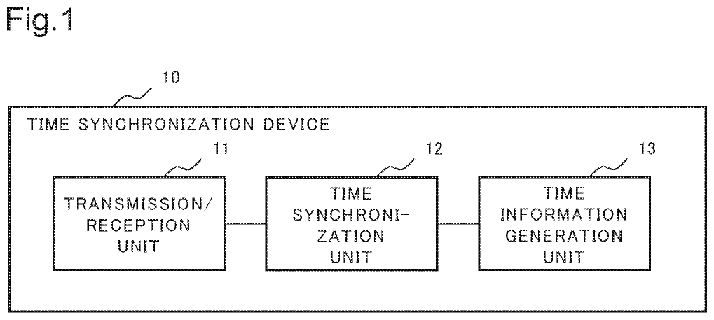

FIG. 1 illustrates a configuration example of the time synchronization device 10 according to the present example embodiment. The time synchronization device 10 includes a transmission/reception unit 11, a time synchronization unit 12, and a time information generation unit 13.

The transmission/reception unit 11 transmits/receives a packet. The time information generation unit 13 generates internal time information indicating an internal time. The internal time is a time inside the time synchronization device 10.

The time synchronization unit 12 performs time synchronization processing. The time synchronization processing is processing of synchronizing the internal time with a master time being a time of a master device. Synchronization of the internal time is performed by using a packet for time synchronization transmitted between the master device and the time synchronization device 10.

The time synchronization unit 12 inhibits inhibition target processing being processing of at least a part of the time synchronization processing when at least one of transmission and reception of a packet other than the packet for time synchronization is performed by the transmission/reception unit 11. Further, the time synchronization unit 12 performs the inhibition target processing when transmission and reception of a packet other than the packet for time synchronization are not performed by the transmission/reception unit 11.

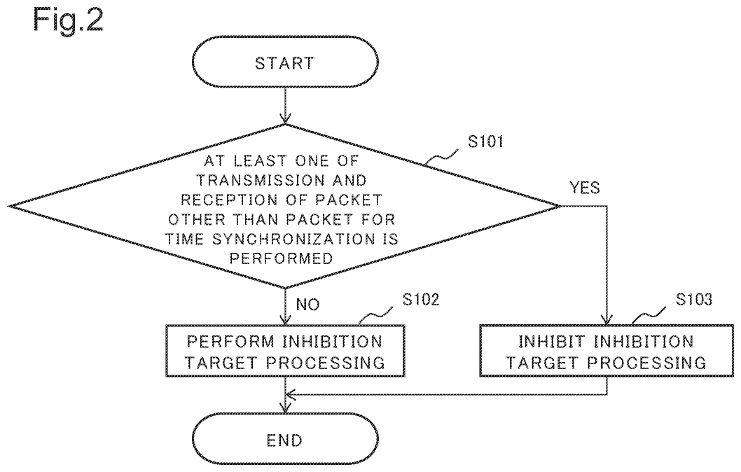

Next, FIG. 2 illustrates an example of an operation flow of the time synchronization device 10 according to the present example embodiment.

The time synchronization unit 12 performs inhibition target processing (Step S102) when transmission and reception of a packet other than a packet for time synchronization are not performed by the transmission/reception unit 11 (NO in Step S101). Further, the time synchronization unit 12 inhibits inhibition target processing (Step S103) when at least one of transmission and reception of a packet other than a packet for time synchronization is performed by the transmission/reception unit 11 (YES in Step S101).

As described above, according to the first example embodiment of the present invention, the time synchronization device 10 includes the transmission/reception unit 11, the time synchronization unit 12, and the time information generation unit 13. The transmission/reception unit 11 transmits/receives a packet. The time information generation unit 13 generates internal time information indicating an internal time. The internal time is a time inside the time synchronization device 10. The time synchronization unit 12 performs time synchronization processing. The time synchronization processing is processing of synchronizing the internal time with a master time being a time of a master device. Synchronization of the internal time is performed by using a packet for time synchronization transmitted between the master device and the time synchronization device 10. The time synchronization unit 12 inhibits inhibition target processing being processing of at least a part of the time synchronization processing when at least one of transmission and reception of a packet other than the packet for time synchronization is performed by the transmission/reception unit 11. Further, the time synchronization unit 12 performs the inhibition target processing when transmission and reception of a packet other than the packet for time synchronization are not performed by the transmission/reception unit 11.

Normally, not only a packet for time synchronization but also a normal packet (for example, a packet for transmission control protocol (TCP) communication) is transmitted/received over a LAN. When a relay device not compliant with a time synchronization scheme (for example, PTP or the like) is used and the relay device also transmits/receives a normal packet, time synchronization precision deteriorates, as described in NPL 1 (Seiko Solutions Inc., “Time Synchronization Efforts for 4K/8K Broadcasting: Part 2”, [online], [retrieved on Aug. 18, 2022], the Internet <URL:https://www.seiko-sol.co.jp/ip_live production/no-02/>). Meanwhile, even when a relay device is not compliant with a time synchronization scheme, deterioration of time synchronization precision can be prevented, as long as no packet other than a packet for time synchronization is transmitted/received to/from the relay device.

Further, even when a relay device compliant with a time synchronization scheme is used, the relay device is more or less affected by transmission/reception of a packet other than a packet for time synchronization. In addition, time synchronization precision may deteriorate.

The time synchronization device 10 according to the present example embodiment performs inhibition target processing when transmission and reception of a packet other than a packet for time synchronization are not performed, and inhibits inhibition target processing when at least one of transmission and reception of a packet other than a packet for time synchronization is performed. This can prevent deterioration of time synchronization precision due to transmission/reception of a normal packet by a relay device, in both cases when a relay device compliant with a time synchronization scheme is used and when not used. Thus, precision in time synchronization can be improved.

### Second Example Embodiment

Next, a second example embodiment of the present invention will be described. One specific example of the time synchronization device according to the first example embodiment is the time synchronization device 20-i according to the second example embodiment.

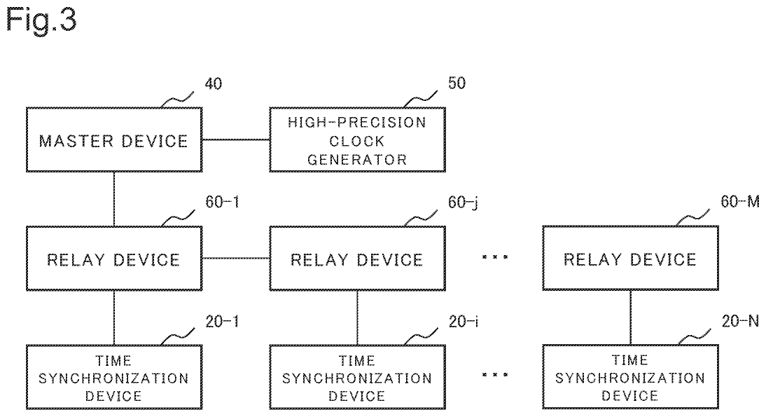

First, FIG. 3 illustrates a configuration example of a system including the time synchronization device 20-i according to the present example embodiment. The system illustrated in FIG. 3 includes a master device 40, a relay device 60-j (j is an integer from 1 to M), and the time synchronization device 20-i (i is an integer from 1 to N). Note that, one or a plurality of equal to or more than two time synchronization devices 20-i can connect to one relay device 60-j.

The master device 40 performs high-precision time synchronization on a master time being an internal time of the master device 40, by using a radio signal from a GNSS satellite (not illustrated) or time information from a high-precision clock generator 50. Further, the master device 40 transmits/receives a packet for time synchronization to/from the time synchronization device 20-i. Note that, the packet for time synchronization is, for example, a packet for PTP, the network time protocol (NTP), or the like. Further, a time synchronization scheme is not limited to PTP or NTP.

The relay device 60-j transmits/receives a packet. The relay device 60-j is, for example, a Layer 2 switch or the like. In a case of the present example embodiment, the relay device 60-j may be compliant with a time synchronization scheme such as PTP, or may not be compliant with a time synchronization scheme. Note that, in the example in FIG. 3, one or a plurality of equal to or more than two relay devices are present between the master device 40 and the time synchronization device 20-i, but there may be the time synchronization device 20-i connected to the master device 40 with no relay device interposed therebetween.

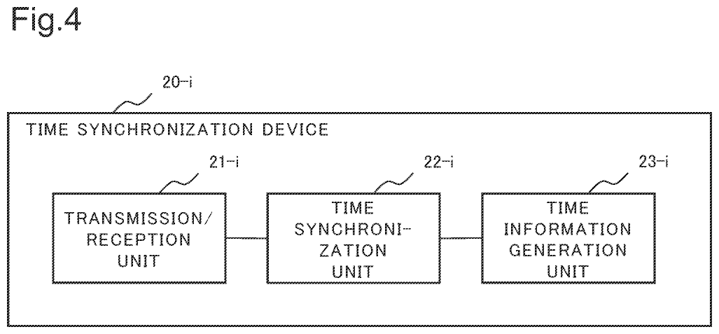

Next, FIG. 4 illustrates a configuration example of the time synchronization device 20-i according to the present example embodiment. The time synchronization device 20-i includes a transmission/reception unit 21-i, a time synchronization unit 22-i, and a time information generation unit 23-i.

The transmission/reception unit 21-i is connected to the master device 40 and/or the relay device 60-j via an Ethernet (registered trademark) port, a small form factor pluggable (SFP) port, or the like. The transmission/reception unit 21-i transmits/receives a packet. Packets transmitted/received by the transmission/reception unit 21-i include a packet for time synchronization and a packet other than the packet for time synchronization. The packet for time synchronization is transmitted between the master device 40 and the time synchronization device 20-i.

The time information generation unit 23-i generates internal time information indicating an internal time of the time synchronization device 20-i. The internal time is counted up by an internal clock being a clock for an internal time.

The time synchronization unit 22-i performs time synchronization processing. The time synchronization processing is processing of synchronizing the internal time of the time synchronization device 20-i with a master time being a time of the master device 40. (Hereinafter, when simply described as an “internal time”, the internal time indicates the internal time of the time synchronization device 20-i.) Synchronization of the internal time is performed by using a packet for time synchronization transmitted between the master device 40 and the time synchronization device 20-i.

The time synchronization unit 22-i inhibits inhibition target processing when at least one of transmission and reception of a packet other than a packet for time synchronization is performed by the transmission/reception unit 21-i. The inhibition target processing is processing of at least a part of the time synchronization processing, and is processing subject to the inhibition. The time synchronization unit 22-i performs the inhibition target processing when transmission and reception of a packet other than a packet for time synchronization are not performed by the transmission/reception unit 21-i.

The time synchronization processing includes processing of transmitting a packet for time synchronization between the master device and the time synchronization device 20-i. Further, the time synchronization processing includes processing of calculating a propagation time between the master device 40 and the time synchronization device 20-i. Further, the time synchronization processing includes processing of synchronizing an internal time with a master time, based on the calculated propagation time. The inhibition target processing includes, among pieces of the time synchronization processing, for example, processing of calculating a propagation time between the master device 40 and the time synchronization device 20-i and processing of synchronizing an internal time with a master time, based on the calculated propagation time. Further, the inhibition target processing may include processing of transmitting a packet for time synchronization between the master device 40 and the time synchronization device 20-i.

More specifically, for example, the time synchronization unit 22-i starts time synchronization processing, as long as transmission and reception of a packet other than a packet for time synchronization are not performed by the transmission/reception unit 21-i. The time synchronization unit 22-i transmits/receives, in the time synchronization processing, a packet for time synchronization to/from the master device via the transmission/reception unit 21-i. Then, the time synchronization unit 22-i calculates a propagation time between the master device 40 and the time synchronization device 20-i, and synchronizes an internal time with a master time, based on the propagation time and time information stored in the packet for time synchronization.

The propagation time between the master device 40 and the time synchronization device 20-i is calculated based on, for example, times T1 to T4. The time T1 is a transmission time of a packet for time synchronization (a first packet) transmitted by the master device 40 to the time synchronization device 20-i. The time T2 is a reception time of the first packet received by the time synchronization device 20-i. The time T3 is a transmission time of a packet for time synchronization (a second packet) transmitted by the time synchronization device 20-i to the master device 40. The time T4 is a reception time of the second packet received by the master device 40.

For example, when a time synchronization scheme is PTP, the time T1 is a transmission time of a Sync message at the master device 40. The time T2 is a reception time of the Sync message at the time synchronization device 20-i. The time T3 is a transmission time of a Delay Request message at the time synchronization device 20-i. The time T4 is a reception time of the Delay Request message at the master device 40. Information of the time T1 is transmitted by the Sync message or a Follow up message from the master device 40 to the time synchronization device 20-i. Information of the time T4 is transmitted by a Delay Response message from the master device 40 to the time synchronization device 20-i.

Then, the time synchronization unit 22-i calculates a round-trip propagation time, based on the times T1 to T4. The round-trip propagation time can be calculated by a general method. Further, the time synchronization unit 22-i calculates a one-way propagation time being half the round-trip propagation time, and subtracts the time T1 and the one-way propagation time from the time T2, thereby calculating a deviation of an internal time from a master time. The time synchronization unit 22-i synchronizes the internal time with the master time, based on the calculated deviation. Specifically, the time synchronization unit 22-i corrects the internal time by using the calculated deviation. Further, the time synchronization unit 22-i may adjust a frequency of an internal clock, based on the calculated deviation. Further, the time synchronization unit 22-i may synchronize the internal time with the master time by reflecting, on the internal time, a time acquired by adding the one-way propagation time to the time T1. Note that, in this case, it is assumed that a period of time between reception of a first packet by the time synchronization device 20-i and synchronization of the internal time be short enough to be ignored. Further, a method of synchronizing the internal time with the master time is not limited to the above-described method.

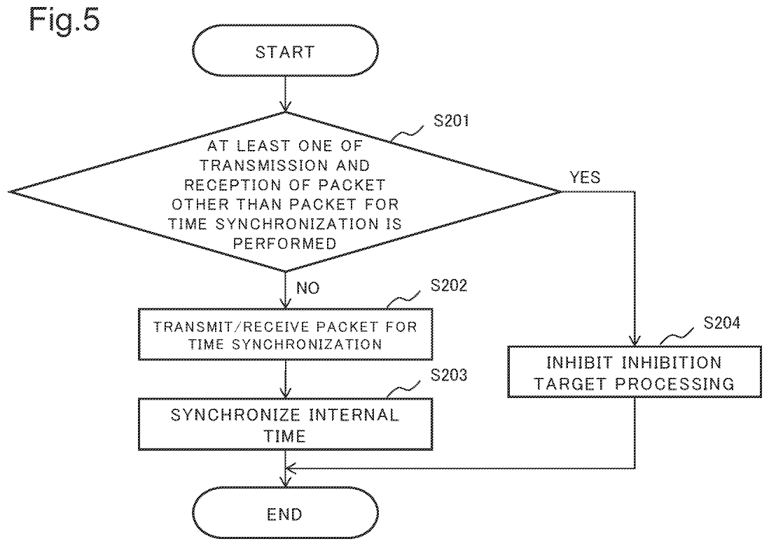

Next, an example of an operation flow of the time synchronization device 20-i according to the present example embodiment will be described by using FIG. 5.

The time synchronization device 20-i executes an operation illustrated in FIG. 5 at predetermined timing. The predetermined timing is, for example, every predetermined time. The predetermined time may be in order of seconds or shorter than seconds, or may be in order of minutes or hours. Further, the predetermined timing may be a case of meeting a predetermined condition. The predetermined condition is, for example, when precision of internal time information can no longer be guaranteed for some reason such as a malfunction, or the like.

The time synchronization unit 22-i checks whether at least one of transmission and reception of a packet other than a packet for time synchronization is performed by the transmission/reception unit 21-i. Then, when transmission and reception of a packet other than a packet for time synchronization are not performed by the transmission/reception unit 21-i (NO in Step S201), a packet for time synchronization is transmitted/received to/from the master device 40 (Step S202).

Next, the time synchronization unit 22-i calculates a propagation time by using times T1 to T4. Then, the time synchronization unit 22-i synchronizes an internal time with a master time, based on the calculated propagation time (Step S203).

Further, the time synchronization unit 22-i inhibits inhibition target processing (Step S204) when at least one of transmission and reception of a packet other than a packet for time synchronization is performed by the transmission/reception unit 21-i (YES in Step S201). Note that, in this case, the inhibition target processing is processing of Steps S202 and S203. That is, the time synchronization unit 22-i does not perform operations of Steps S202 and S203 when at least one of transmission and reception of a packet other than a packet for time synchronization is performed by the transmission/reception unit 21-i.

Note that, when even a few packets other than a packet for time synchronization are transmitted/received during transmission/reception of the packet for time synchronization in Step S202, synchronization precision may be affected. Thus, a period of time between checking of transmission/reception of a packet other than a packet for time synchronization in Step S201 and execution of Step S202 is desirably as short as possible.

Further, the time synchronization unit 22-i can execute Step S202, as long as transmission and reception of a packet other than a packet for time synchronization are not performed at execution timing of Step S201. For example, when transmission/reception of a packet other than a packet for time synchronization is performed at equal time intervals, the time synchronization unit 22-i can execute time synchronization processing in a period of time therebetween (a period of time during which transmission/reception of a packet other than a packet for time synchronization is not performed).

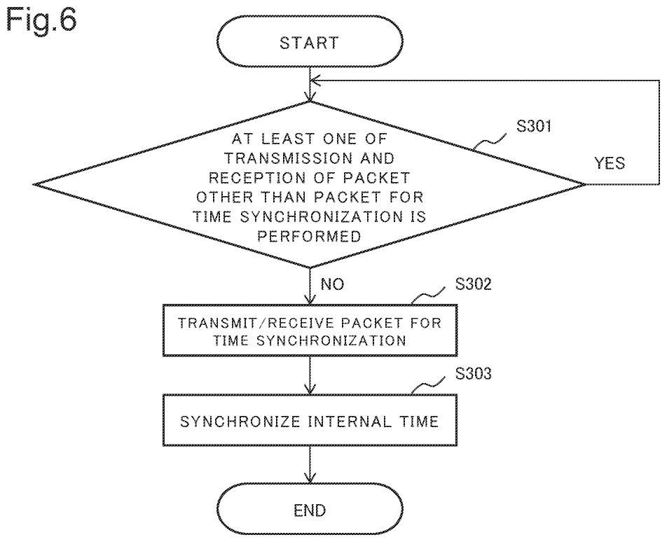

Further, the time synchronization unit 22-i may execute Step S201 again after a waiting time for a predetermined period of time when at least one of transmission and reception of a packet other than a packet for time synchronization is performed in Step S201. FIG. 6 illustrates an example of an operation flow of the time synchronization device 20-i in this case. Note that, Step S201 in FIG. 5 is equivalent to Step S301 in FIG. 6.

Further, the time synchronization unit 22-i may check whether at least one of transmission and reception of a packet other than a packet for time synchronization is performed during transmission/reception of the packet for time synchronization. Then, the time synchronization unit 22-i may not use a transmitted/received packet for time synchronization in time synchronization processing when at least one of transmission and reception of a packet other than the packet for time synchronization is performed.

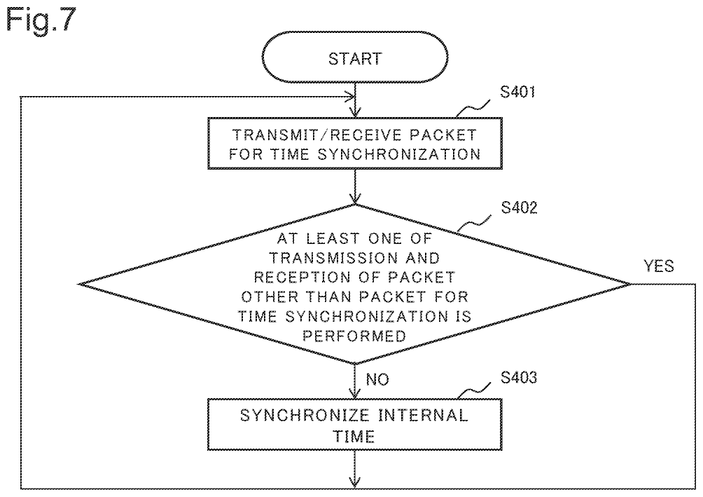

FIG. 7 illustrates an example of an operation flow of the time synchronization device 20-i in this case.

For example, it is assumed that the master device 40 transmits a first packet (for example, a Sync message) at predetermined timing such as every predetermined time.

In this case, for example, the time synchronization unit 22-i transmits a second packet (for example, a Delay Request message) to the master device 40 via the transmission/reception unit 21-i (Step S401) when the first packet transmitted by the master device 40 is received by the transmission/reception unit 21-i.

Further, the time synchronization unit 22-i checks whether at least one of transmission and reception of a packet other than a packet for time synchronization is performed by the transmission/reception unit 21-i. For example, the time synchronization unit 22-i checks whether at least one of transmission and reception of a packet other than a packet for time synchronization is performed by the transmission/reception unit 21-i during transmission/reception of the packet for time synchronization in Step S401. When transmission and reception of a packet other than a packet for time synchronization are not performed by the transmission/reception unit 21-i (NO in Step S402), the time synchronization unit 22-i calculates a propagation time by using times T1 to T4. Then, the time synchronization unit 22-i synchronizes an internal time with a master time, based on the calculated propagation time (Step S403).

Further, the time synchronization unit 22-i inhibits inhibition target processing when at least one of transmission and reception of a packet other than a packet for time synchronization is performed by the transmission/reception unit 21-i (YES in Step S402). Note that, in this case, the inhibition target processing is processing of Step S403. That is, the time synchronization unit 22-i does not perform an operation of Step S403 when at least one of transmission and reception of a packet other than a packet for time synchronization is performed by the transmission/reception unit 21-i.

Further, in the operation flow in FIG. 5 or 6, the time synchronization unit 22-i may check whether transmission/reception of a packet other than a packet for time synchronization occurs during transmission/reception of the packet for time synchronization. Then, the time synchronization unit 22-i may end time synchronization processing without correcting an internal time when at least one of transmission and reception of a packet other than a packet for time synchronization occurs during transmission/reception of the packet for time synchronization. Further, in this case, the time synchronization unit 22-i may start the flow in FIG. 5 or 6 again from beginning.

Next, a case in which the time synchronization device 20-i according to the present example embodiment is applied to a base station in a radio access scheme will be described.

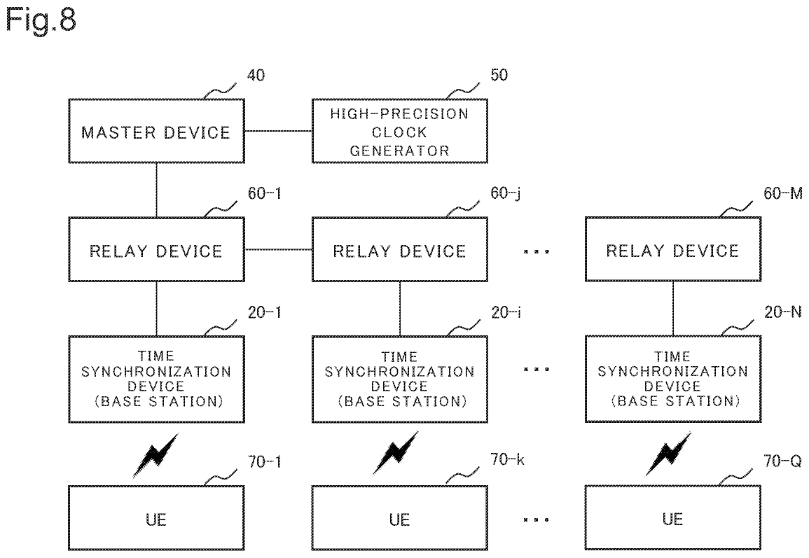

FIG. 8 illustrates a configuration example of a system including the time synchronization device 20-i in this case. In the system illustrated in FIG. 8, the time synchronization device 20-i is a base station. Further, the time synchronization device 20-i is connected from user equipment (UE). In the example in FIG. 8, there are Q pieces of UE (UE 70-k: k is an integer from 0 to Q).

Note that, one or a plurality of equal to or more than two pieces of UE can connect to one time synchronization device (base station). Further, there may be the time synchronization device 20-i not connected to UE. Further, although not illustrated, a base station that performs time synchronization by using a method not transmitting/receiving a packet for time synchronization, for example, a base station that performs time synchronization by using a radio signal from a GNSS satellite may be connected to the relay device 60-j.

In this case, the time synchronization device 20-i has a function as a base station for radio communication. For example, the time synchronization device 20-i has a function of performing control relating to connection of UE. The control relating to connection of UE is, for example, control relating to connection of new UE, or control relating to movement (handover) of UE between base stations. Further, the time synchronization device 20-i has a function of transferring a data packet transmitted/received between UE and a LAN. Note that, in this case, the LAN is a network including the time synchronization device 20-i and the relay device 60-j. Further, the time synchronization device 20-i has a function of transmitting/receiving a radio signal to/from UE. The radio signal is, for example, but not limited to, a signal for 5G or LTE.

Further, in this case, the time synchronization unit 22-i of the time synchronization device 20-i may further inhibit inhibition target processing when control relating to connection of UE or transfer of a data packet is performed. When control relating to connection of UE or transfer of a data packet is performed, a packet other than a packet for time synchronization is transmitted/received by the transmission/reception unit 21-i. By inhibiting inhibition target processing in such a case, inhibition target processing in a case in which a relay device transmits/receives a packet other than a packet for time synchronization is inhibited, and thus, deterioration of precision in time synchronization processing due to transmission/reception of a packet other than a packet for time synchronization by a relay device can be prevented.

As described above, according to the second example embodiment of the present invention, the time synchronization device 20-i includes the transmission/reception unit 21-i, the time synchronization unit 22-i, and the time information generation unit 23-i. The transmission/reception unit 21-i transmits/receives a packet. The time information generation unit 23-i generates internal time information indicating an internal time. The internal time is a time inside the time synchronization device 20-i. The time synchronization unit 22-i performs time synchronization processing. The time synchronization processing is processing of synchronizing the internal time with a master time being a time of a master device. Synchronization of the internal time is performed by using a packet for time synchronization transmitted between the master device and the time synchronization device 20-i. The time synchronization unit 22-i inhibits inhibition target processing being processing of at least a part of the time synchronization processing when at least one of transmission and reception of a packet other than the packet for time synchronization is performed by the transmission/reception unit 21-i. Further, the time synchronization unit 22-i performs the inhibition target processing when transmission and reception of a packet other than the packet for time synchronization are not performed by the transmission/reception unit 21-i.

In this way, the time synchronization device 20-i according to the present example embodiment performs inhibition target processing when transmission and reception of a packet other than a packet for time synchronization are not performed, and inhibits inhibition target processing when at least one of transmission and reception of a packet other than a packet for time synchronization is performed. This can prevent deterioration of time synchronization precision due to transmission/reception of a normal packet by a relay device. Thus, precision in time synchronization can be improved.

Further, a system can be constructed without using a relay device compliant with a time synchronization scheme such as PTP. Thereby, in selecting equipment for a relay device, a relay device can be selected from among many options. Further, an existing relay device can be used. In particular, when a time synchronization scheme is PTP, the time synchronization device 20-i according to the present example embodiment enables system construction without using a PTP-compliant relay device, which can reduce a system construction cost.

Further, inhibition target processing includes processing of calculating a propagation time between the master device 40 and the time synchronization device 20-i, based on a transmission/reception time of a packet for time synchronization and synchronizing an internal time with a master time, based on the calculated propagation time. Thereby, precision in a propagation time can be improved and precision in time synchronization can be improved, in a time synchronization scheme of calculating a propagation time, based on a transmission/reception time of a packet for time synchronization and performing time synchronization.

Further, inhibition target processing may include processing of transmitting a packet for time synchronization between the master device and the time synchronization device 20-i.

Further, when inhibition target processing is inhibited, the time synchronization unit 22-i may perform time synchronization processing including the inhibition target processing when transmission and reception of a packet other than a packet for time synchronization are not performed by the transmission/reception unit 21-i after a predetermined period of time of waiting. In this case, even when inhibition target processing is inhibited, time synchronization processing can be performed at timing when the time synchronization processing is possible.

Further, the time synchronization unit 22-i performs time synchronization processing including inhibition target processing when transmission and reception of a packet other than a packet for time synchronization are not performed by the transmission/reception unit 21-i during transmission/reception of the packet for time synchronization. Thereby, time synchronization precision can be further improved.

Further, the time synchronization device 20-i may be a base station. In this case, the time synchronization unit 22-i may further inhibit inhibition target processing when control relating to connection of UE is performed. Thereby, precision in time synchronization can be improved.

[Hardware Configuration Example]

A configuration example of a hardware resource that achieves the above-described time synchronization device (10, 20) according to each example embodiment of the present invention by using one information processing device (computer) will be described. Note that, the time synchronization device may be achieved by using physically or functionally at least two information processing devices. Further, the time synchronization device may be achieved as a dedicated device. Further, only a partial function of the time synchronization device may be achieved by using an information processing device.

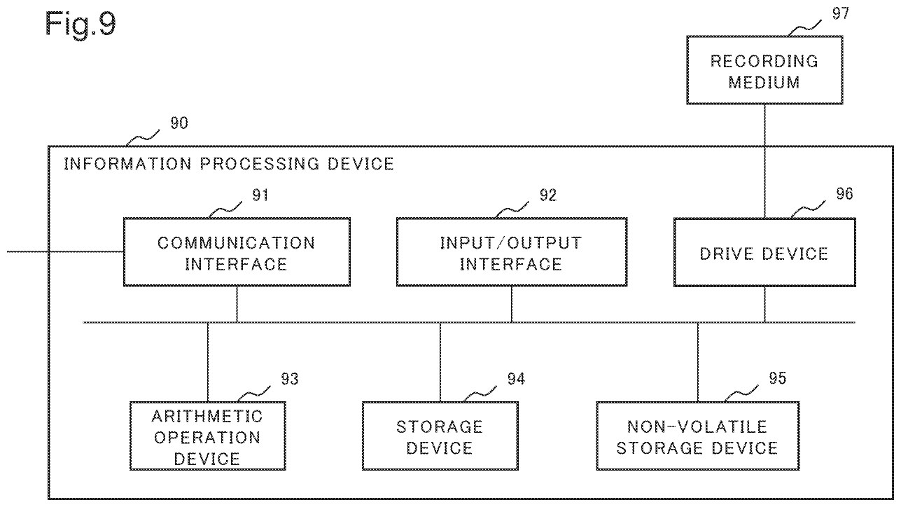

FIG. 9 is a diagram schematically illustrating a hardware configuration example of an information processing device that can achieve the time synchronization device according to each example embodiment of the present invention. An information processing device 90 includes a communication interface 91, an input/output interface 92, an arithmetic operation device 93, a storage device 94, a non-volatile storage device 95, and a drive device 96.

For example, the transmission/reception unit 11 in FIG. 1 can be achieved by the communication interface 91. The time synchronization unit 12 can be achieved by the arithmetic operation device 93.

The communication interface 91 is a communication means by which the time synchronization device according to each example embodiment communicates with an external device by wire or/and wirelessly. Note that, when the time synchronization device is achieved by using at least two information processing devices, the devices may be connected to each other in a way mutually communicable via the communication interface 91.

The input/output interface 92 is a man-machine interface such as a keyboard being one example of an input device or a display as an output device.

The arithmetic operation device 93 is achieved by an arithmetic operation processing device such as a general-purpose central processing unit (CPU) or a microprocessor, or by a plurality of electric circuits. The arithmetic operation device 93 is capable of, for example, reading out various types of programs stored in the non-volatile storage device 95 into the storage device 94 and executing processing according to the read-out program.

The storage device 94 is a memory device such as a random access memory (RAM) that can be referred to from the arithmetic operation device 93, and stores a program, various types of data, or the like. The storage device 94 may be a volatile memory device.

The non-volatile storage device 95 is, for example, a non-volatile storage device such as a read only memory (ROM) or a flash memory, and is capable of storing various types of programs, data, or the like.

The drive device 96 is, for example, a device that processes reading and writing of data on a recording medium 97 to be described later.

The recording medium 97 is, for example, any recording medium that is capable of recording data, such as an optical disk, a magneto-optical disk, or a semiconductor flash memory.

Each example embodiment of the present invention may be achieved by, for example, configuring a time synchronization device with the information processing device 90 illustrated in FIG. 9, and supplying, to the time synchronization device, a program that can achieve a function described in the above example embodiment.

In this case, the example embodiment can be achieved by the arithmetic operation device 93 executing the program supplied to the time synchronization device. Further, not only all but also a part of the function of the time synchronization device can be configured with the information processing device 90.

Furthermore, the time synchronization device may be configured in such a way that the above program is recorded in the recording medium 97 and, in a stage of shipping the time synchronization device, an operational stage, or the like, the above program is stored in the non-volatile storage device 95 as appropriate. Note that, in this case, as a method of supplying the above program, a method of installing the above program in the time synchronization device by using an appropriate jig in a manufacture stage before shipping, an operational stage, or the like may be employed. Further, as a method of supplying the above program, a general procedure such as a method of downloading the above program from outside via a communication line such as the Internet may be employed.

The whole or part of the example embodiments disclosed above can be described as, but not limited to, the following supplementary notes.

(Supplementary Note 1)

A time synchronization device connecting to a master device, including:
a transmission/reception unit that transmits/receives a packet;
a time information generation unit that generates internal time information indicating an internal time being a time inside the time synchronization device; and
a time synchronization unit that performs time synchronization processing being processing of synchronizing the internal time with a master time being a time of the master device, wherein
synchronization of the internal time is performed by using a packet for time synchronization transmitted between the master device and the time synchronization device, and
the time synchronization unit inhibits inhibition target processing being processing of at least a part of the time synchronization processing when at least one of transmission and reception of a packet other than the packet for time synchronization is performed by the transmission/reception unit, and performs the inhibition target processing when transmission and reception of a packet other than the packet for time synchronization are not performed by the transmission/reception unit.

(Supplementary Note 2)

The time synchronization device according to supplementary note 1, wherein
the inhibition target processing includes processing of calculating a propagation time between the master device and the time synchronization device, based on a transmission/reception time of the packet for time synchronization, and synchronizing the internal time with the master time, based on the propagation time.

(Supplementary Note 3)

The time synchronization device according to supplementary note 2, wherein
the inhibition target processing includes processing of transmitting the packet for time synchronization between the master device and the time synchronization device.

(Supplementary Note 4)

The time synchronization device according to supplementary note 1, wherein,
when the inhibition target processing is inhibited, the time synchronization unit performs the time synchronization processing including the inhibition target processing when transmission and reception of a packet other than the packet for time synchronization are not performed by the transmission/reception unit after a predetermined period of time of waiting.

(Supplementary Note 5)

The time synchronization device according to supplementary note 1, wherein
the time synchronization unit performs time synchronization processing including the inhibition target processing when transmission and reception of a packet other than the packet for time synchronization are not performed by the transmission/reception unit during transmission of the packet for time synchronization.

(Supplementary Note 6)

The time synchronization device according to supplementary note 1, wherein
the time synchronization device is a base station, and
the time synchronization unit further inhibits the inhibition target processing when control relating to connection of user equipment (UE) is performed.

(Supplementary Note 7)

A time synchronization method for a time synchronization device connecting to a master device, the method including:
transmitting/receiving a packet;
generating internal time information indicating an internal time being a time inside the time synchronization device; and
performing time synchronization processing being processing of synchronizing the internal time with a master time being a time of the master device when transmission and reception of a packet other than a packet for time synchronization are not performed, and inhibiting inhibition target processing being processing of at least a part of the time synchronization processing when at least one of transmission and reception of a packet other than the packet for time synchronization is performed, wherein
synchronization of the internal time is performed by using a packet for time synchronization transmitted between the master device and the time synchronization device.

(Supplementary Note 8)

The time synchronization method according to supplementary note 7, wherein
the inhibition target processing includes processing of calculating a propagation time between the master device and the time synchronization device, based on a transmission/reception time of the packet for time synchronization, and synchronizing the internal time with the master time, based on the propagation time.

(Supplementary Note 9)

The time synchronization method according to supplementary note 8, wherein
the inhibition target processing includes processing of transmitting the packet for time synchronization between the master device and the time synchronization device.

(Supplementary Note 10)

The time synchronization method according to supplementary note 7, further including,
when inhibiting the inhibition target processing, performing time synchronization processing including the inhibition target processing when transmission and reception of a packet other than the packet for time synchronization are not performed after a predetermined period of time of waiting.

(Supplementary Note 11)

The time synchronization method according to supplementary note 7, further including
performing time synchronization processing including the inhibition target processing when transmission and reception of a packet other than the packet for time synchronization are not performed during transmission of the packet for time synchronization.

(Supplementary Note 12)

The time synchronization method according to supplementary note 7, wherein
the time synchronization device is a base station, and
the time synchronization method further includes
inhibiting the inhibition target processing when control relating to connection of UE is performed.

(Supplementary Note 13)

A non-transitory computer-readable recording medium on which a time synchronization program of a time synchronization device connecting to a master device is recorded, the program causing a computer to achieve:
a transmission/reception function of transmitting/receiving a packet;
a time information generation function of generating internal time information indicating an internal time being a time inside the time synchronization device; and
a time synchronization function of performing time synchronization processing being processing of synchronizing the internal time with a master time being a time of the master device, wherein
synchronization of the internal time is performed by using a packet for time synchronization transmitted between the master device and the time synchronization device, and
the time synchronization function inhibits inhibition target processing being processing of at least a part of the time synchronization processing when at least one of transmission and reception of a packet other than the packet for time synchronization is performed by the transmission/reception function, and performs the inhibition target processing when transmission and reception of a packet other than the packet for time synchronization are not performed by the transmission/reception function.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

1. A time synchronization device connecting to a master device, the time synchronization device comprising one or more memories storing instructions and one or more processors configured to execute the instructions to:
transmit/receive a packet;
generate internal time information indicating an internal time being a time inside the time synchronization device; and
perform time synchronization processing being processing of synchronizing the internal time with a master time being a time of the master device when transmission and reception of a packet other than a packet for time synchronization are not performed, and inhibit inhibition target processing being processing of at least a part of the time synchronization processing when at least one of transmission and reception of a packet other than the packet for time synchronization is performed, wherein
synchronization of the internal time is performed by using a packet for time synchronization transmitted between the master device and the time synchronization device.

2. The time synchronization device according to claim 1, wherein
the inhibition target processing includes processing of calculating a propagation time between the master device and the time synchronization device, based on a transmission/reception time of the packet for time synchronization, and synchronizing the internal time with the master time, based on the propagation time.

3. The time synchronization device according to claim 2, wherein
the inhibition target processing includes processing of transmitting the packet for time synchronization between the master device and the time synchronization device.

4. The time synchronization device according to claim 1, wherein,
when the inhibition target processing is inhibited, the one or more processors are configured to execute the instructions to perform the time synchronization processing including the inhibition target processing when transmission and reception of a packet other than the packet for time synchronization are not performed by the transmission/reception unit after a predetermined period of time of waiting.

5. The time synchronization device according to claim 1, wherein
the one or more processors are configured to execute the instructions to perform the time synchronization processing including the inhibition target processing when transmission and reception of a packet other than the packet for time synchronization are not performed by the transmission/reception unit during transmission of the packet for time synchronization.

6. The time synchronization device according to claim 1, wherein
the time synchronization device is a base station, and
the one or more processors are configured to execute the instructions to inhibit the inhibition target processing when control relating to connection of user equipment (UE) is performed.

7. A time synchronization method for a time synchronization device connecting to a master device, the method comprising:
transmitting/receiving a packet;
generating internal time information indicating an internal time being a time inside the time synchronization device; and
performing time synchronization processing being processing of synchronizing the internal time with a master time being a time of the master device when transmission and reception of a packet other than a packet for time synchronization are not performed, and inhibiting inhibition target processing being processing of at least a part of the time synchronization processing when at least one of transmission and reception of a packet other than the packet for time synchronization is performed, wherein
synchronization of the internal time is performed by using a packet for time synchronization transmitted between the master device and the time synchronization device.

8. The time synchronization method according to claim 7, wherein
the inhibition target processing includes processing of calculating a propagation time between the master device and the time synchronization device, based on a transmission/reception time of the packet for time synchronization, and synchronizing the internal time with the master time, based on the propagation time.

9. The time synchronization method according to claim 8, wherein
the inhibition target processing includes processing of transmitting the packet for time synchronization between the master device and the time synchronization device.

10. A non-transitory computer-readable recording medium on which a time synchronization program of a time synchronization device connecting to a master device is recorded, the program causing a computer to achieve:
a transmission/reception function of transmitting/receiving a packet;
a time information generation function of generating internal time information indicating an internal time being a time inside the time synchronization device; and
a time synchronization function of performing time synchronization processing being processing of synchronizing the internal time with a master time being a time of the master device, wherein
synchronization of the internal time is performed by using a packet for time synchronization transmitted between the master device and the time synchronization device, and
the time synchronization function inhibits inhibition target processing being processing of at least a part of the time synchronization processing when at least one of transmission and reception of a packet other than the packet for time synchronization is performed by the transmission/reception function, and performs the inhibition target processing when transmission and reception of a packet other than the packet for time synchronization are not performed by the transmission/reception function.
